(19) United States
(12) Patent Application Publication
(10) Pub. No.: US 2009/0309016 A1
(43) Pub. Date: Dec. 17, 2009

(54) Method and apparatus for Detecting Explosives

(75) Inventors: Jose Almirall, Miami, FL (US); Jeannette Perr, Miami, FL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: The Florida International University Board of Trustees, Miami, FL (US)

(21) Appl. No.: 11/630,559

(22) PCT Filed: Feb. 2, 2006
(86) PCT No.: PCT/US06/04074

§ 371 Date: Jul. 16, 2009

Related U.S. Application Data
(60) Provisional application No. 60/649,464, filed on Feb. 2, 2005.

(51) Int. Cl. H01J 49/40

(52) U.S. Cl. 250/282; 250/286

(57) ABSTRACT

An interface that couples SPME to IMS has been constructed and evaluated for the detection of the following detection taggants: 2-nitrotoluene (2-NT), 4-nitrotoluene (4-NT), and 2,3-dimethyl-2,3-dinitrobutane (DMNB). The interface was also evaluated for the following common explosives: smokeless powder (nitrocellulose, NC), 2,4-dinitrotoluene (2,4-DNT), 2,6-dinitrotoluene (2,6-DNT), 2,4,6-trinitrotoluene (2,4,6-TNT), hexahydro-1,3,5-trinitro-s-triazine (RDX), and pentaerythritol tetranitrate (PETN). The resultant SPME-IMS interface was found to extract volatile constituent chemicals and detection taggants in explosives from a headspace for subsequent detection in a simple, rapid, sensitive, and inexpensive manner.

### FIELD OF THE INVENTION

The present invention is generally directed to systems for detecting explosives, and, more particularly, to a method and apparatus for extracting volatile constituent chemicals and detection taggants in explosives for subsequent detection.

### BACKGROUND OF THE INVENTION

Ion mobility spectrometry (IMS) is a rugged, inexpensive, sensitive, field portable technique for the detection of organic compounds. It is widely employed in ports of entry and by the military as a particle detector for explosives and drugs of abuse. Many organic high explosives do not have a high enough vapor pressure for effective vapor sampling. However, these explosives and their commercial explosive mixtures have characteristic volatile components detectable in their headspace. In addition, taggants are added to commercially-manufactured explosives to aid in detection through headspace sampling. Solid phase microextraction (SPME) is an effective extraction technique that has been successfully employed in the field for the pre-concentration of a variety of compounds. SPME can easily extract these compounds from the headspace for IMS vapor detection.

In 1996, Congress passed the Anti Terrorism Bill that requires the addition of detection taggants to plastic explosive compounds and the ban of sale or import of plastic explosives that do not contain a detection agent [Public Law 104-132, Antiterrorism and Effective Death Penalty Act of 1996; Section 603; Apr. 24, 1996]. A detection taggant is a solid or liquid vapor emitting substance added to an explosive material to facilitate discovery before detonation. A detection taggant can easily be detected by explosive vapor detectors, such as ion mobility spectrometers (IMS). IMS are currently used as particle detectors requiring the manual transfer of particles from a suspect area and thermal desorption into the spectrometer.

Many organic high explosives, particularly those found in plastic explosives, do not produce a significant vapor pressure to allow headspace vapor detection, especially in the field [R. G. Ewing, C. J. Miller, Field Anal. Chem. Technol., 5:215-221 (2001)]. The International Civil Aviation Organization (ICAO) has designated the detection taggant compounds as the following four compounds in concentrations by mass: 0.5% 2-nitrotoluene (2-NT), 0.5% 4-nitrotoluene (4-NT), 0.1% 2,3-dimethyl-2,3-dinitrobutane (DMNB), and 0.2% ethylene glycol dinitro (EGDN) [Convention on the Marking of Plastic Explosives for the Purpose of Detection, http://www.iasl.mcgill.ca/airlaw/public/aviation_security/montreal1991.pdf, accessed Dec. 11, 2003]. These compounds were selected because they are not commonly found in nature, they do not hinder the explosive properties of the tagged compound, they continue to release their vapors at a steady rate for 5 to 10 years, they do not present a significant environmental hazard, and they do not readily adhere to common substances the taggant may come in contact with [J. Yinon, Forensic Applications of Mass Spectrometry, CRC Press, Boca Raton, Fla., 1995]. In addition to taggant detection to determine if an improvised explosive device is present, there are also additional odor signature compounds present in significant amounts for detection [M. Williams, J. M. Johnston, M. Cicoria, E. Paletz, L. P. Waggoner, C. Edge, S. F. Hallowell, Proc. SPIE, 35:291-301 (1998)].

The Transportation Security Administration (TSA) has mandated that all airports in the United States screen all bags for explosives [http://www.aviationnow.com/avnow/news/channel_comm.jsp?view=story & id=news/capt1130.xml, accessed Mar. 12, 2003]. IMS is one of the screening tools approved by the TSA. These instruments can detect the taggants selected by the ICAO [R. G. Ewing, D. A. Atkinson, G. A. Eiceman, G. J. Ewing, Talanta, 54:515-529 (2001)]. Detector dog teams are another widely used screening tool [D. S. Moore, Rev. Sci. Instrum., 75:2499-2512 (2004)]. The results presented in this application are part of a study using detector dogs as models for reliable real-time explosive vapor detection [K. G. Furton, L. G. Myers, Talanta, 54:487-500 (2001)]. This includes identifying the dominant available odor signature chemicals available for detection and using these newly identified compounds for detection of explosives via SPME-IMS and gas chromatography mass spectrometry (GC/MS) to emulate the presumptive screening the dog detector teams conduct. The utility of the IMS is greatly enhanced by using SPME-IMS vapor sampling instead of particle sampling because of the increase in sampling efficiency and improved sensitivity.

IMS

IMS is a presumptive detection method for organic compounds that is extremely fast, straightforward to use, low cost, with clear-cut data interpretation, excellent sensitivity, and low power demands. Run times for commercial ion mobility spectrometers range from 1 s to 7 s. IMS machines have a large installed base of over 10,000 commercial instruments and 50,000 military instruments conducting over 10,000,000 analyses per year [K. Cottingham, Anal. Chem., 75:435A-439A (2003)]. The false positive rate for swabbing of suspected area is reported to be less than 1% while the false positive rate for air sampling of suspected areas is less than 0.1% [Itemiser Contraband (Drug and Explosive) Detection and Identification System User's Manual revision 3.1., GE Ion Track Instruments, Wilmington, Mass. (1999)]. For example, when 17 of the most likely false positives for 2,4,6-trinitrotoluene (2,4,6-TNT) were studied, it was found that only seven of those were detected by the ion mobility spectrometer and upon careful analysis, the compound that displayed the most similar mobility to TNT 4,6-dinitro-o-cresol (4,6-DN-o-C), did not produce a false positive [L. M. Matz, P. S. Tornatore, H. H. Hill, Talanta, 54:171-179 (2001)]. IMS has also been evaluated as a field screening application and found to have a number of advantages over other field deployable techniques [H. H. Hill, G. Simpson, Field Anal. Chem. Technol., 1:119-134 (1997)].

In IMS, ions are separated and recognized on the basis of their mobility values. Some instruments can analyze only positive or negative ions in a determination while others instruments can analyze both positive and negative ions in the same analytical determination. The detection of explosives and taggants are typically conducted in the negative ion mode. Mobility (K in cm²/V s) is determined using the drift velocity (v_{d} in cm/s) of the ion through a heated drift tube and the weak electric field (E in V/cm) that the ion is exposed to when inside the heated drift tube (v_{d}=E×K). Ionization occurs in the reaction region when a ⁶³Ni source initiates ionization by emitting β particles. The β particles trigger a cascade of ionization reactions, either with the air or with the air or with dopant gas present in the ionization region, to produce reactant ions. The reactant ions interact with the sample through ion molecule interactions to generate product ions that are detected during the analysis. Other ionization methods can be used, such as a tritium β particle emitter [J. W. Leonhardt, J Radioanal. Nucl. Chem., 206:333 (1996)], photoionization [D. D. Lubman, M. N. Kronick, Anal. Chem., 54:1546 (1982); C. S. Lesure, M. E. Fleischer, G. K. Anderson, G. A. Eiceman, Anal. Chem., 58:2142 (1996); H. Borsdorf, H. Schelhorn, J. Flachowsky, H. Döring, J. Stach, Anal. Chim. Acta., 403:235-242 (2000)], and corona discharge [R. A. Miller, E. G. Nazarov, G. A. Eiceman, T. A. King, Sens. Actuators A, 91:301-312 (2001)], but ionization using the ⁶³Ni source is the most common. Ionization results in either molecular ion or molecular clusters related to the molecular ion. Fragmentation is a rare occurrence but it has been observed in very special cases [K. Cottingham, Anal. Chem., 75:452A (2003)].

Also during IMS, an electronic gate opens at timed intervals throughout the run to allow the ions to enter the drift region for separation to occur. The opening of the electronic gate begins the timing of the ion's flight time to reach the detector in order to calculate the drift velocity. A linear potential drop exists in the drift region to move the reactant and product ions towards the detector. Neutrals and ions of the opposite charge being analyzed are swept out of the drift region by a counter-current flow of drift gas. A plasmagram results as the plot of the current measured at the collector electrode with respect to time in the millisecond (ms) time frame. The General Electric Ion Track Itemiser® 2 collects one plasmagram every 100 ms. For a 7 s run, 70 plasmagrams are recorded. The 70 collected plasmagrams then undergo a data deconvolution step in which a representative plasmagram is produced. An intensity map views all the plasmagrams collected during one run stacked on each other showing height as intensity. Dark areas represent peaks while lighter areas represent troughs. A single plasmagram can be imported into Excel and graphed.

An important factor that affects mobility is collisional cross section area (Ω_{d} in Å²). The mean free path of an ion with a large collisional cross section is shorter than those of a smaller collisional cross section. If two molecules have the same collisional cross section, the heavier molecule will have a longer mean free path due to its slower velocity. The dopant gas and air within the drift tube affect the drift velocity (v_{d}) by collisions, making IMS a quasi mass analyzer but instead of using only mass to charge (m/z) it uses three different parameters: shape (collisional cross section), mass, and charge.

SPME

SPME is a highly effective sample extraction pre-concentration technique that has been shown to be an effective tool for the analysis of volatile and semi-volatile components and was named one of the six great ideas in analytical chemistry of the last decade [K. G. Furton, J. Wang, Y. L. Hsu, J. Walton, J. R. Almirall, J. Chromatogr. Sci., 38:297-306 (2000); K. G. Furton, J. R. Almirall, M. Bi, J. Wang, W. Lu, J Chromatogr. A, 885:419-432 (2000); K. P. Kirkbride, G. Klass, P. E. Pigou, J Forensic Sci., 43:76-81 (1998); J. Handley, C. M. Harris, Anal. Chem., 73:23A-26A (2001)]. Volatile or semi-volatile compounds are extracted either by absorption or adsorption onto a non-volatile polymeric coating or solid sorbent phase. After the analytes are absorbed onto the SPME phase they are commonly desorbed by heat in an injection port. SPME devices come in a variety of forms including but not limited to: particles coated in the SPME phase, vessels lined with the SPME phase, and SPME coated stir bars. A common and commercially available form of SPME is the fiber configuration. SPME has been successfully applied to the recovery of explosives and explosive vapors followed by GC/MS and HPLC analysis [J. R. Almirall, L. Wu, M. Bi, M. W. Shannon, K. G. Furton, Proc. SPIE, 35:18-23 (1999); K. G. Furton, L. Wu, J. R. Almirall, J Forensic Sci., 45:845-852 (2000); K. G. Furton, R. J. Harper, J. M. Perr, J. R. Almirall, Proc. SPIE, 5071:183-192 (2003)]. Polydimethyl siloxane (PDMS) fibers have been reported as the most effective and rugged fiber for rapid headspace extraction of explosives with the least amount of carry-over problems [N. Lorenzo, T. Wan, R. J. Harper, Y. Hsu, M. Chow, S. Rose, K. G. Furton, J Anal. Bioanal. Chem., 376:1212-1224 (2003)] for explosive compounds.

SPME is a very effective tool for the extraction of taggants from headspace samples under ambient environmental conditions that can also be used for remote sampling. Ion mobility spectrometry is a very effective tool for detecting trace amounts of explosives and explosive taggants under ambient environmental conditions [M. Nambayah, T. I. Quickenden, Talanta, 63:461-467 (2004)]. Ion mobility spectrometers have been successfully interfaced to other sample introduction techniques such as a solid phase extraction (SPE) [T. L. Buxton, P. B. Harrington, Appl. Spectrosc., 57:223-232 (2003)], gas chromatography (GC) [J. P. Dworzanski, W. H. McClennen, P. A. Cole, S. N. Thornton, H. L. C. Meuzelaar, N. S. Arnold, A. P. Snyder, Field Anal. Chem. Technol., 1:295-305 (1997)], and liquid chromatography (LC) [S. J. Valentine, M. Kulchania, C. A. S. Barnes, D. E. Clemmer, Int. J. Mass Spectrom., 212:97-109 (2001)].

A SPME-IMS interface was created to couple the extraction efficiency of SPME to the detection capability of IMS. The demand for this sort of field portable, remote, reliable sampling is high [J. Yinon, Anal Chem., 75:99A-105A (2003)]. The SPME-ISM interface shown meets this need by extracting detection taggants and characteristic volatile components of explosives from a headspace for subsequent detection by a commercially available IMS in a simple, rapid, sensitive, and inexpensive manner.

### SUMMARY OF THE DISCLOSURE

An apparatus for pre-concentration of any one or more of volatile compounds, explosives; and taggants in explosives for subsequent detection by an ion mobility spectrometry is disclosed. The apparatus comprises a tube having an inlet; a resistor for heating the tube; a connector fitted to the inlet; a septum fitted and sealed to the connector; and a solid phase microextraction (SPMS) fiber adapted to be first exposed to an atmosphere that has been exposed to an object that may contain a volatile compound, an explosive, taggants in explosives, or mixtures thereof, thereby allowing for the pre-concentration of any one or more of the compounds, explosives, and taggants in explosives within said object. The SPMS fiber is further adapted to be introduced into the pre-concentration apparatus at the septum after such exposure for thermal desorption and introduction of any one or more of the concentrated compounds, explosives, and taggants in explosives into an ion mobility spectrometer (IMS) for detection of any such explosive in said object.

Also disclosed is a method for pre-concentrating any one or more of volatile compounds, explosives, and taggants in explosives for subsequent detection by an ion mobility spectrometry. The method comprises the steps of: (1) exposing an SPME fiber to an atmosphere in an enclosure containing a test object, thereby allowing for the pre-concentration of one or more of volatile compounds, explosives, and taggants of explosives within said object; and (2) introducing the SPME fiber into an apparatus for thermal desorption and introduction of one or more of volatile compounds, explosives, and taggants in explosives into an ion mobility spectrometry (IMS) for detection of the explosive.

Another method for pre-concentrating any one or more of volatile compounds, explosives, and taggants in explosives for subsequent detection by an ion mobility spectrometry is also disclosed. The method comprises the steps of: (1) contacting a test object with a volume of gas; (2) exposing an SPME fiber to said gas to pre-concentrate any volatile compounds, explosives, and taggants of explosives within said object; and (3) introducing the SPME fiber into an apparatus for thermal desorption and introduction of one or more of volatile compounds, explosives, and taggants in explosives into an ion mobility spectrometry (IMS) for detection of the explosive.

The invention itself, together with further objects and attendant advantages, will be best understood by reference to the following detailed description, taken in conjunction with the accompanying drawings.

### BRIEF DESCRIPTION OF THE DRAWINGS

FIG. 1 is a first schematic representation of the SPME-IMS interface.

FIG. 2 depicts processed plasmagrams of the following materials: 1000 μL of 2-nitrotoluene (2-NT) in a 10 mL headspace vial extracted for 5 min at ambient conditions; 1000 μL of 4-nitrotoluene (4-NT) in a 10 mL headspace vial extracted for 5 min at ambient conditions; 0.2560 g of 2,3-dimethyl-2,3-dinitro butane (DMNB) in a 10 mL headspace vial extracted for 5 min at ambient conditions run positive ionization mode with a drift tube temperature of 40° C., 0.2560 g of nitrocellulose (NC) in a 10 mL headspace vial extracted for 5 min at ambient conditions; 0.29303 g of 2,4-dinitrotoluene (2,4-DNT) in a 10 mL headspace vial extracted for 5 min at ambient conditions; 0.21243 g of 2,6-dinitrotoluene (2,6-DNT) in a 10 mL headspace vial extracted for 5 min at ambient conditions; 0.2626 g of 2,4,6-trinitrotoluene (2,4,6-TNT) in a 10 mL headspace vial extracted for 5 min at ambient conditions; 0.2566 g of hexahydro-1,3,5-trinitro-s-triazine (RDX) in a 10 mL headspace vial extracted for 10 min at ambient conditions; and, 0.1496 g of pentaerythritol tetranitrate (PETN) in a 10 mL headspace vial extracted for 5 min at ambient conditions.

FIG. 3 is a second schematic representation of the SPME-IMS interface, which also includes an interface housing and related components.

FIG. 4 is a chart depicting the differences in results using IMS technology and an SPME-IMS interface.

FIG. 5 is a front perspective view of an SPME-IMS interface in accordance with the present invention.

FIG. 6 is a partial top view of the interface of FIG. 5.

FIG. 7 is a partial front view of the apparatus of FIG. 5.

### DETAILED DESCRIPTION

An interface that couples SPME to IMS has been constructed and evaluated for the detection of the following detection taggants: 2-nitrotoluene (2-NT), 4-nitrotoluene (4-NT), and 2,3-dimethyl-2,3-dinitrobutane (DMNB). The interface was also evaluated for the following common explosives: smokeless powder (nitrocellulose, NC), 2,4-dinitrotoluene (2,4-DNT), 2,6-dinitrotoluene (2,6-DNT), 2,4,6-trinitrotoluene (2,4,6-TNT), hexahydro-1,3,5-trinitro-s-triazine (RDX), and pentaerythritol tetranitrate (PETN). The resultant interface was found to extract volatile constituent chemicals and detection taggants in explosives from a headspace for subsequent detection in a simple, rapid, sensitive, and inexpensive manner.

### Materials and Methods

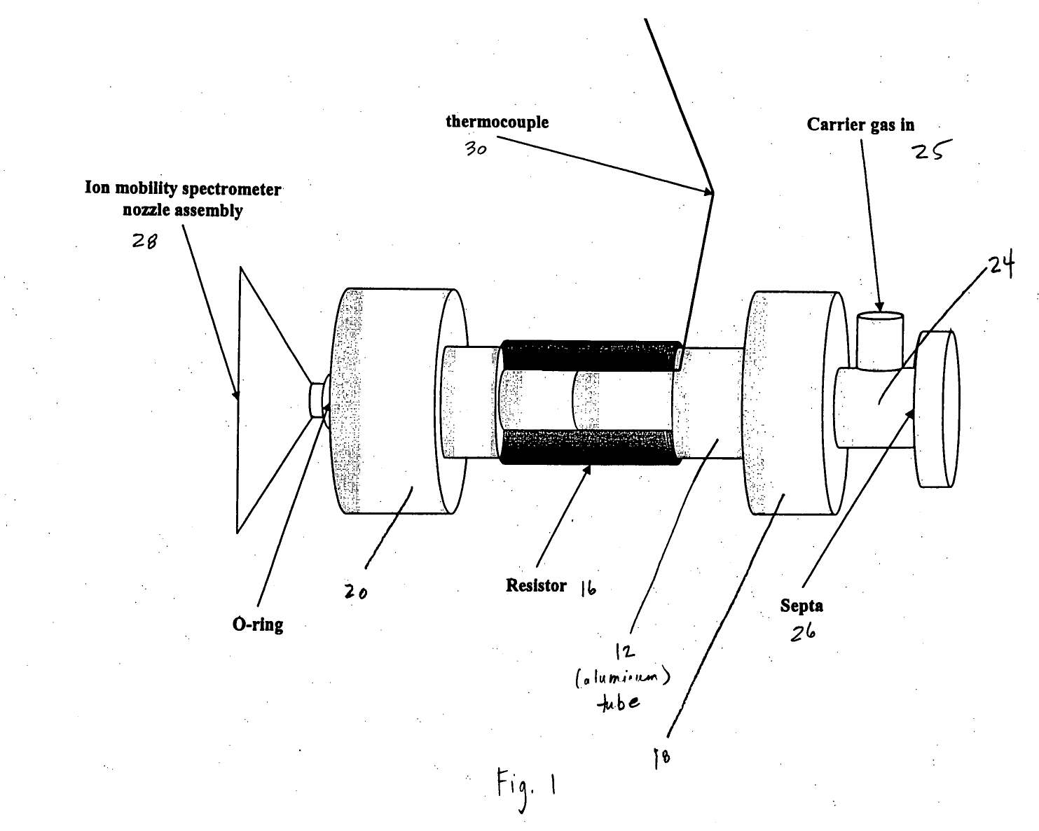

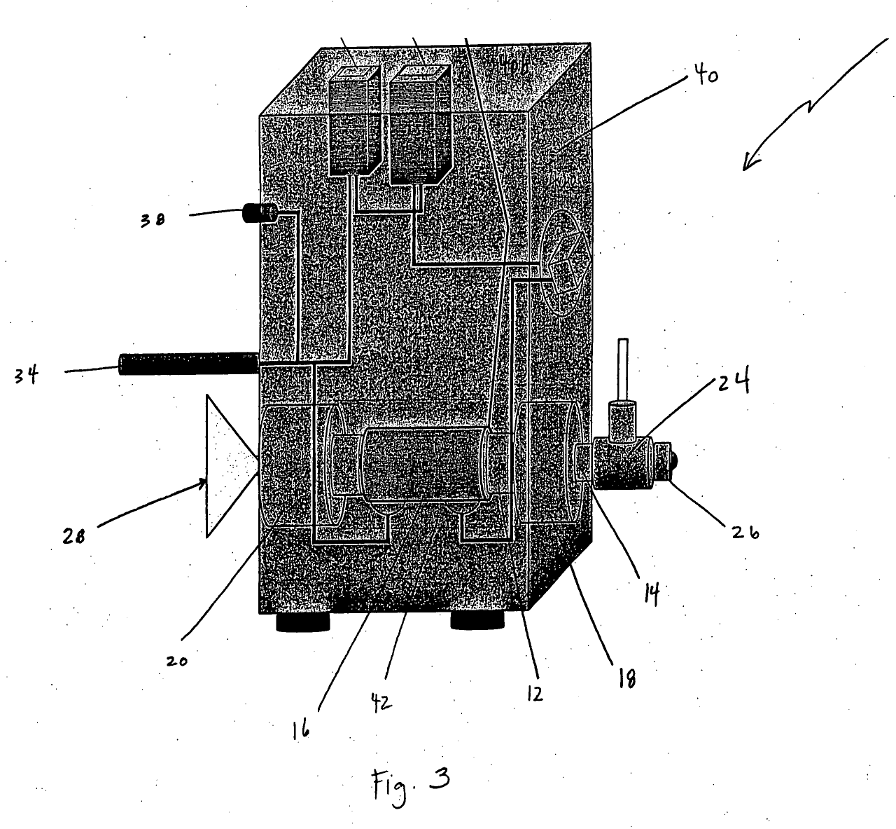

Referring now to FIG. 1, the Solid Phase Microextraction Ion Mobility Spectrometry (SPME-IMS) interface 10 of the present invention is shown. The SPME-IMS interface 10 is a second generation prototype that was constructed for less than $1000 (US). An aluminum tube 12 was machined to form an inlet 14 (see FIG. 3) that could be heated using a resistor 16. A pentiostat 22 (see FIG. 3) was used to provide current to the resistor 16, for example. A first aluminum cylindrical heating block 18 and a second aluminum heating block 20 may also be disposed on or near opposite ends of the aluminum tube 12, as shown in FIGS. 1 and 3. The inlet 14 was coated with a +1200 Å Silcosteel® layer treatment (Restek, Bellefonte, Pa.) to deactivate the surface. Ultra high purity helium carrier gas (Air Products, Allentown, Pa.), the heat generated by the resistor 16, and the first and second cylindrical heating blocks 18, 20 were used to desorb the analytes off a SPME fiber. A calibrated 150 mm aluminum 15-turn high-accuracy valve flow meter from Gilmont® Instruments (Barrington, Ill.) was used to control the flow of helium through the SPME-IMS interface. Of course, various other types of valve flow meters may be used in conjunction with the interface of the present invention, as this particular model is representative only. A Swagelok ## in. union “t” connector 24, purchased from Florida Fluid Systems Technologies, Inc. (Sunrise, Fla.) was fitted onto the sample thermal desorption inlet 14 (see FIG. 3). A 5 mm Thermogreen septum 26 was machine punched out from an 11 mm Thermogreen Supelco (Bellefonte, Pa.) septa using a custom designed punch. The 5 mm septum 26 was fitted into one of the caps on the union “t” connector 24 and sealed in place using the back ferrule of the ## in. union “t” connector. Again, of course, other types of septa and connectors may be used in accordance with the interface of the present invention, as the aforementioned components, while used in the SPMS-IMS interface described herein, are representative only. The total length of the SPME-IMS device is 11 cm.

Referring now to FIG. 3, the SPMS-IMS interface 10 further includes a housing 40. The housing 40 may be formed of metal, a metal blend, or other material. A thermocouple 30 is also shown (see also FIG. 1), which senses the temperature of the resistor 16 based on the principle that voltage is produced when two dissimilar metals are joined; the voltage relates to the difference in temperature between a measuring junction and a reference junction, a connection to a measuring device, e.g., the resistor 16. The pentiostat 22 may be disposed on a first side 40a of the housing 40, as shown in FIG. 3, for example. A fuse 32 and a power switch 36 are disposed on a second side 40b of the housing 40, and a power cord 34 is disposed on a third side 40c of the interface housing 40. Of course, the pentiostat 22, the fuse 32, the power switch 36, and the power cord 34 may alternatively be disposed on other areas of the housing, resulting in alternative configurations that would not depart in the least from the spirit and scope of the present invention. An ion mobility spectrometer inlet nozzle 28, which is attached to interface 10 near the second aluminum cylindrical heating block, is also disposed on the third side 40c of the housing 40. Lastly, an insulating material 42, such as a glass wool insulating material, encircles the resistor 16.

Before operation of the SPME-IMS interface, an SPME fiber, such as polydimethyl siloxane (PDMS), is first exposed to air or another gaseous atmosphere in an enclosed space containing an object, e.g., a suitcase or other container having a volume sufficient to contain an explosive, allowing for a pre-concentration of compounds, such as volatile compounds of explosives. The SPME fiber is then introduced into the interface 10 through the septum 26 for thermal desorption and introduction of the concentrated volatiles into the IMS. The IMS then detects the volatile compounds, indicating that explosives are present.

During testing of the SPME-IMS interface 10, polydimethyl siloxane (PDMS) solid phase microextraction fibers were obtained from Supelco (Bellefonte, Pa.). TuffSyringe field portable SPME fiber holders with teflon seal were obtained from Field Forensics (St. Petersburg, Fla.). A General Electric Ion Track (Wilmington, Mass.) Ion Mobility Spectrometer, the Itemiser® 2, was used to detect the compounds of interest. The Itemiser® 2 has a thin film membrane in front of the drift tube that prevents dirt and moisture from entering into the system. This membrane improves ionization efficiency and sensitivity over other conventional ion mobility spectrometers.

In addition, the taggants 2-nitrotoluene (2-NT), 4-nitrotoluene (4-NT), and 2,3-dimethyl-2,3-dinitrobutane (DMNB) were obtained from Aldrich Chemical Company, Inc. (Milwaukee, Wis.). Compounds found in the headspace of common explosives, 2,4-nitrotoluene (2,4-DNT) and 2,6-dinitrotoluene (2,6-DNT), were also obtained from Aldrich Chemical Company Inc. (Milwaukee, Wis.). Small samples of smokeless powder (nitrocellulose), 2,4,6-trinitrotoluene (2,4,6-TNT), hexahydro-1,3,5-nitro-s-triazine (RDX), and pentaerytritol tetranitrate (PETN) were donated by the Miami Dade Police Department (Miami, Fla.). Explosives and taggants used in the limit of detection experiment were purchased from Supelco (Bellefonte, Pa.) in 1,000 μg/L concentrations.

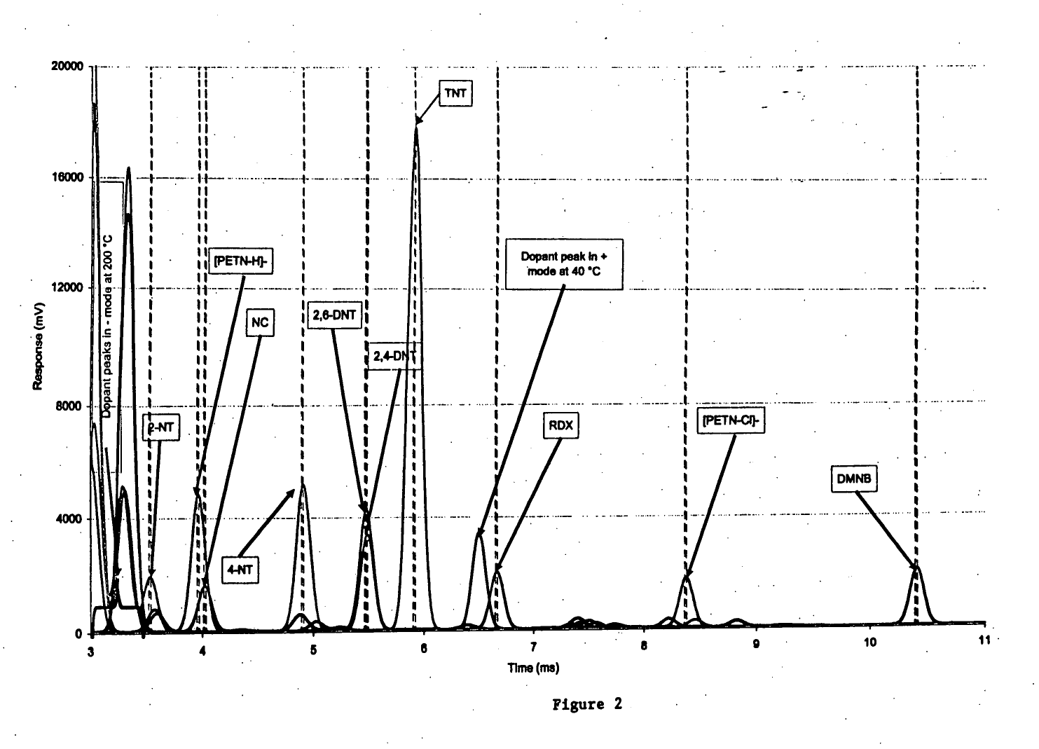

To determine the viability of the SPME-IMS interface, known amounts of the compounds of interest were placed in 10 mL headspace vials manufactured by Supelco (Bellefonte, Pa.) and sampled for known amounts of time using a PDMS fiber. FIG. 2 shows the processed plasmagram for the different compounds that were extracted using SPME-IMS under different conditions. A Varian (Walnut Creek, Calif.) 3400cx gas chromatograph/Saturn 2000 ion trap mass spectrometer (GC/MS) was used to confirm that the PDMS SPME fiber was extracting the compounds of interest. Operating conditions for the GC/MS, ion mobility spectrometer, and SPME-IMS interface can be found in Table 1. The SPME device was inserted into the interface before data acquisition began. Once acquisition had started, the fiber was exposed. The optimized temperature of the interface was determined to be 260° C. using 2 min extractions of 0.2560 g of DMNB in a 10 mL headspace vial with a PDMS SPME fiber and the GC/MS method described in Table 1. The optimal flow rate was determined to be 1000 mL/min from the average plasmagram signal produced from 5 min SPME PDMS extractions of 0.2626 g 2,4,6-trinitrotoluene (2,4,6-TNT) in a 10 mL headspace vial and the SPME-IMS method described in Table. The limit of detection of the SPME-IMS interface was determined by spiking known amounts of the compounds of interest into quart sized cans, extracting at ambient conditions with the SPME PDMS fiber for a known amount of time, running the fiber by GC/MS to determine the mass via GC/MS calibration curves, and then repeating the experiment with analysis by the IMS. The limit of detection of the IMS in standard mode was determined by spiking known amounts of the compound of interest on to filter paper and then plotting calibration curves. The response required for detection was set at 50 mV. The results of these experiments are shown in Table 2.

DMNB degrades at elevated drift tube temperature. The resulting ions can be used for detection of DMNB; however, the molecular ion can be detected in positive ion mode at reduced drift tube temperatures [W. A. Munro, C. L. Thomas, M. L. Lanford, Anal. Chim. Acta., 375:49-63 (1998)]. In this work, DMNB was analyzed at the reduced drift tube temperature of 40° C. and in the positive ion mode.

### Results and Discussion

The SPME-IMS interface 10 was designed to operate similarly to the injection port of a GC. The injection port of a GC efficiently desorbs the compounds off the SPME phase using thermal desorption as does the SPME-IMS interface. The injection port of a GC and the SPME-IMS interface do not significantly damage the fiber, allowing reuse of the fiber. The inner diameter of the GC injection port and the SPME-IMS interface tube 12 are reduced to allow a tight plug of the compound to form before analysis. The SPME-IMS interface 10 was also designed to be used as an add-on accessory for current ion mobility spectrometers.

The SPME-IMS interface 10 septum 26 was replaced after 50 injections. The SPME fiber needle drills out a small section of septum 26 each time a sample is introduced, accelerating septa failure. Any failure to accurately control and maintain temperature via the resistor 16 results in a marked decrease in sensitivity of the SPME-IMS instrument. Other forms of heating than the resistor 16, such as ceramic blocks, are being studied for possible incorporation into the SPME-IMS design.

It was shown through a t-test that the compound extracted desorbs rapidly off the fiber and that the run should be started first and the fiber exposed second. When the fiber was exposed before the run a significant loss of response was observed. The peak attributed to the detection taggants and other compounds tested was not observed in either the instrument blank runs, the fiber blank runs, or the vial blank runs.

TABLE 1
Experimental conditions.

| Temperature program | | |
|---|---|---|
| Ramp [° C.] | Final temp. [° C.] | Hold time [min] |

GC/MS Experimental Conditions

| | | |
|---|---|---|
| — | 80 | — |
| 10 | 115 | 0 |
| 15 | 230 | 3.84 |

| | |
|---|---|
| Total run time [min] | 15 |
| Column | Supelco Equity 1 column 25 m × 0.25 mm × 0.25 μm |
| Injector type | Splitless 1078 injector port with Supelco deactivated |
| | glass inlet liner for SPME injections |
| Injector temp. [° C.] | 240 |
| Filament delay [min] | 3.5 |
| Flow rate [mL/min] | 1.3 |
| Ionization method | El Auto |
| Trap temp. [° C.] | 180 |
| Manifold temp. [° C.] | 120 |
| Transfer line temp. [° C.] | 280 |
| m/z range | 40-450 |

IMS Experimental Conditions

| | |
|---|---|
| Selectivity | <1% typical false positive rate on surface wipes, O.1% |
| | on air samples |
| Analysis time[s] | 7 |
| Sample flow [L/min] | 1 |
| Power | 110 V 60 Hz, 150 W |
| Detection mode | Explosives and taggants, negative ion mode; DMNB, |
| | positive ion mode |

SPME-IMS Experimental conditions

| | |
|---|---|
| Interface temp. [° C.] | 260 ± 1 |
| Temp. range [° C.] | Ambient, 100-280 |
| Flow rate of He [mL/min] | 1000 ± 4 |
| Flow rate range [mL/min] | 10-50,000 |
| Warm-up time [h] | 1 |

RDX and PETN do not have significant headspace pressure (4.6×10⁻⁹ torr and 1.4×10⁻⁸ torr at 25° C. respectively) to allow for routine headspace sampling [D. S. Moore, Rev. Sci. Instrum., 75:2499-2512 (2004)]. PETN and RDX were detected using SPME-IMS but not reproducibly. The extraction of PETN by the SPME PDMS fiber has been confirmed using the GC/MS method in Table 1. The PETN sample consisted of a 0.1496 g piece of detonation cord containing a white powder. The extraction of the PETN could be due to direct transfer of very small particles of the white powder onto the fiber but this must be confirmed by conducting experiments to allow only the vapor to be exposed to the SPME fiber. There are two peaks observed in the plasmagram of the PETN sample (FIG. 2). The first peak is the [PETN-H]⁻ ion and the second peak is the [PETN.Cl]⁻ ion. The RDX sample originates from 0.2566 g C4, a plastic explosive. The likelihood of small particles being carried onto the SPME fiber in this scenario is expected to be small due to the plastic nature of the explosive. Using conditions where particle creation is unlikely, it is important to stimulate possible real world scenarios where explosives are contained within improvised explosive devices, yielding limited explosive vapors. It has been very difficult to reproduce the SPME-IMS results using explosives with low vapor pressures, like RDX and PETN. Depletion of the headspace for these samples occurs rapidly due to their low vapor pressures. This is one reason the results are difficult to reproduce. Adequate time must be given when repeatedly sampling the same vial of extremely low vapor pressure explosives, such as RDX and PETN. Current work is underway to determine how long the samples should be allowed to equilibrate in order for sufficient replenishing of the headspace to occur.

TABLE 2
Ratio LOD [ng].

| | Filter paper | SPME-IMS |
|---|---|---|
| 2-Nitrotoluene | N/A | 0.57 |
| 4-Nitrotoluene | N/A | 0.32 |
| 2,4,6-Trinitrotoluene | 0.79 | 0.16 |
| 2,4-Dinitrotoluene | 122.67 | 0.16 |
| 2,6-Dinitrotoluene | 619.83 | 0.24 |
| Tetryl | 24.82 | Not detected |
| RDX | 20.22 | N/A |
| HMX | 17.01 | N/A |
| DMNB | 2.23 | 0.31 |

Experiments with different explosive compounds and volatile compounds that are characteristic of explosives are ongoing in order to determine the optimal target compounds for detection by SPME-IMS.

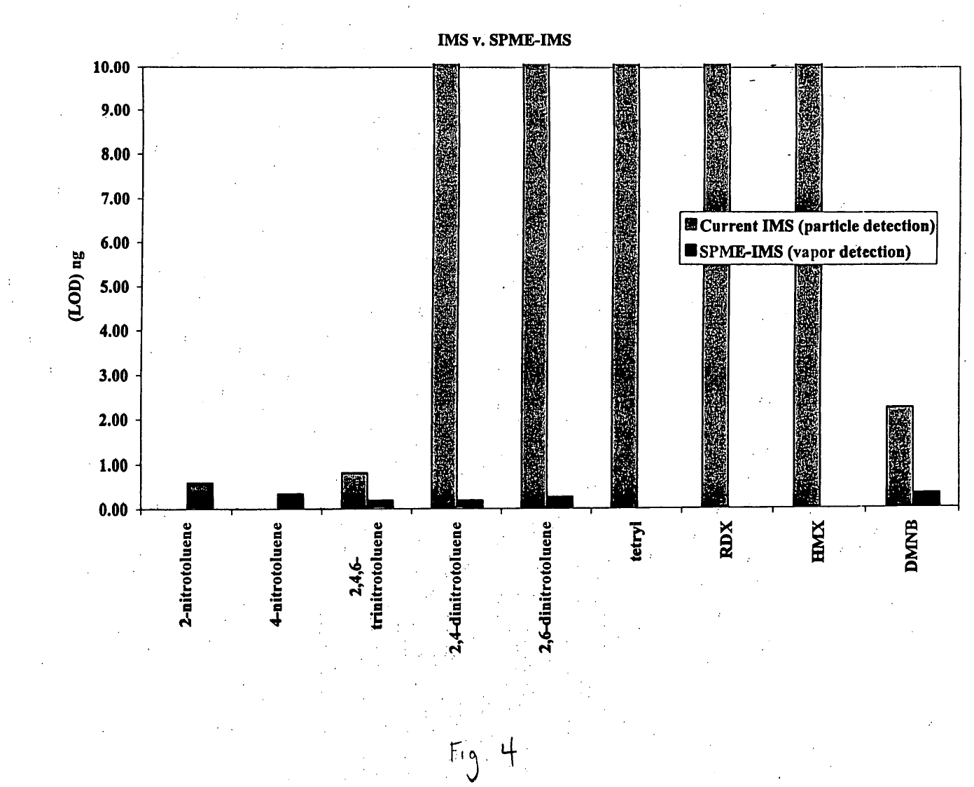

As described, the application of the SPME-IMS interface 10 will allow for the vapor sampling of volatile compounds characteristic of explosives. Using the interface 10 to detect volatile compounds characteristic of explosives will greatly improve the probability of field detection of explosives, as the results in FIG. 4, for example, illustrate. It will also simplify the detection process, and allow for rapid field sampling of large rooms and containers. The current results were achieved with a relatively simple prototype interface and improvements are expected as optimization and additional capabilities are added including, addition of a temperature programmable control, development of field employable remote auto-sampling capabilities, evaluating different SPME phase and forms, as well as exploring a wide range of applications development. Increasing the amount of SPME phase able to participate in extraction may also increase the amount of material extracted and thereby sensitivity as long as the extraction time increase due to increased film thickness does not offset rapid analysis. This may not be a problem as the taggants' vapor pressures are very high and rapid sampling can occur. Improvements in the interface and IMS optimization should allow for decreased extraction times providing useful field operation throughputs while detecting characteristic odor chemicals presently not being detected.

There is already a large installed base of IMS detectors in the United States and several different groups are conducting extensive research and development. SPME-IMS is not limited to explosive compounds, vapor constituents and taggants are more likely to be used for detection of explosive compounds in the future. SPME-IMS can have a large range of applications; all that is required is extraction of the compound by a SPME phase and the ability to detect the compound by IMS. Additional applications include detecting the characteristic volatile chemicals from controlled substances and biohazards.

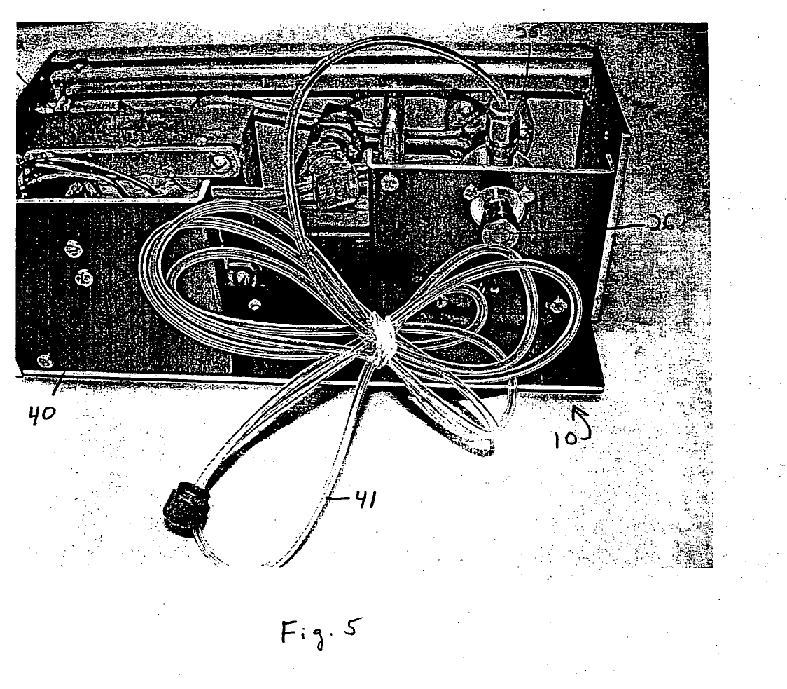

FIGS. 5-7 show a preferred embodiment of an SPME-IMS interface 10 in accordance with the present invention. Interface 10 has an outer housing 40 for mounting the various components of the interface. Flexible tubing 41 conveys a carrier gas from a source (not shown) to carrier gas inlet 25. As noted above, helium is a preferred carrier, but other non-reactive gases could also be used.

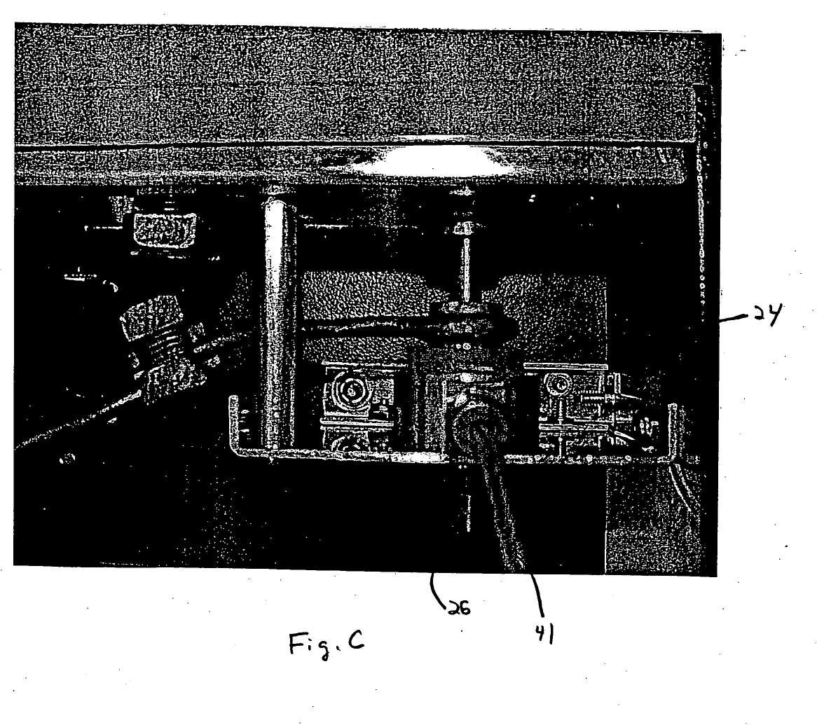

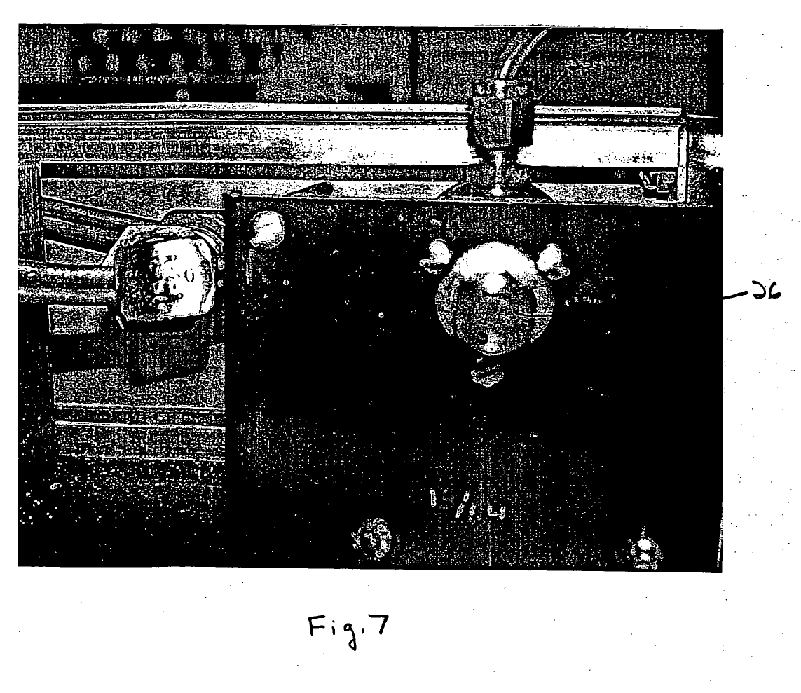

Referring now to FIGS. 6 and 7 a septum 26 is adapted to receive a test sample (not shown). Upon exposure to heat, volatile compounds in the test sample are conveyed by the carrier gas through connector 24. Referring to FIG. 5, heat is supplied by a resistor in the form of resistor block 16a.

The present invention has been described with reference to specific examples, which are intended to be illustrative only and not to be limiting of the invention. It will be apparent to those of ordinary skill in the art that changes, additions, and/or deletions may be made to the disclosed embodiments without departing from the spirit and scope of the invention.

What is claimed is:

1. An apparatus for pre-concentration of any one or more of volatile compounds, explosives, and taggants in explosives for subsequent detection by an ion mobility spectrometry, comprising:
a. a tube having an inlet;
b. a resistor for heating the tube;
c. a connector fitted to the inlet;
d. a septum fitted and sealed to the connector; and
e. a solid phase microextraction (SPMS) fiber adapted to be first exposed to an atmosphere that has been exposed to an object that may contain a volatile compound, an explosive, taggants in explosives, or mixtures thereof, thereby allowing for the pre-concentration of any one or more of the compounds, explosives, and taggants in explosives within said object, said SPMS fiber further adapted to be introduced into the pre-concentration apparatus at the septum after such exposure for thermal desorption and introduction of any one or more of the concentrated compounds, explosives, and taggants in explosives into an ion mobility spectrometer (IMS) for detection of any such explosive in said object.

2. The apparatus of claim 1, further comprising a carrier gas inlet for accepting helium gas.

3. The apparatus of claim 2, further comprising a valve flow meter for controlling the flow of helium through the apparatus.

4. The apparatus of claim 2, wherein the helium gas and resistor help desorb at least one analyte off the SPME fiber.

5. The apparatus of claim 1, wherein the inlet is coated with a +1000 A Silcosteel layer treatment to deactivate a surface of the inlet.

6. The apparatus of claim 1, wherein the apparatus is solid phase microextraction ion mobility (SPMS-IMS) interface.

7. The apparatus of claim 6, wherein the SPMS-IMS interface is adapted to be used with the ion mobility spectrometer.

8. The apparatus of claim 1, wherein the connector is a union t-connector.

9. The apparatus of claim 8, wherein the septum is fitted into a cap on the connector and sealed in place using a back ferrule of the union t-connector.

10. The apparatus of claim 1, wherein the septum is machine punched out from an 11 mm Thermogreen Supelco septa using a custom designed punch.

11. The apparatus of claim 1, wherein the SPMS fiber includes polydimethyl siloxane (PDMS).

12. The apparatus of claim 1, wherein the taggants include 2-nitrotoluene (2-NT), 4-nitrotoluene (4-NT), and 2,3-dimethyl-2,3-dinitrobutane (DMNB).

13. The apparatus of claim 1, wherein the compounds include 2,4-nitrotoluene (2,4-DNT) and 2,6-dinitrotoluene (2,6-DNT).

14. The apparatus of claim 1, wherein the explosives include 2,4,6-trinitrotoluene (2,4,6-TNT), hexahydro-1,3,5-nitro-s-triazine (RDX), and pentaerythritol tetranitrate (PETN).

15. The apparatus of claim 1, further comprising a housing 40.

16. The apparatus of claim 1, further comprising a thermocouple for sensing a temperature of the resistor.

17. The apparatus of claim 15, further comprising a fuse, a power switch, and a power cord.

18. The apparatus of claim 1, further comprising an ion mobility spectrometer inlet nozzle.

19. The apparatus of claim 1, wherein an insulating material encircles the resistor.

20. The apparatus of claim 1, further comprising a programmable temperature control.

21. A method for pre-concentrating any one or more of volatile compounds, explosives, and taggants in explosives for subsequent detection by an ion mobility spectrometry, comprising the steps of:
exposing a solid phase microextraction (SPME) fiber to an atmosphere in an enclosure containing a test object, thereby allowing for the pre-concentration of one or more of volatile compounds, explosives, and taggants of explosives within said object; and
introducing the SPME fiber into an apparatus for thermal desorption and introduction of one or more of volatile compounds, explosives, and taggants in explosives into an ion mobility spectrometry (IMS) for detection of the explosive.

22. The method of claim 21, further comprising the step of detecting the volatile compound from a controlled substance, a biohazard, or both a controlled substance and a biohazard.

23. The method of claim 21, further comprising the step of detecting an odor chemical.

24. The method of claim 21, further comprising the step of evaluating different solid phase microextraction phase forms.

25. The method of claim 21, wherein the SPMS fiber includes polydimethyl siloxane (PDMS).

26. The apparatus of claim 21, wherein the taggants include 2-nitrotoluene (2-NT), 4-nitrotoluene (4-NT), and 2,3-dimethyl-2,3-dinitrobutane (DMNB).

27. The apparatus of claim 21, wherein the compounds include 2,4-nitrotoluene (2,4-DNT) and 2,6-dinitrotoluene (2,6-DNT).

28. The apparatus of claim 21, wherein the explosives include 2,4,6-trinitrotoluene (2,4,6-TNT), hexahydro-1,3,5-nitro-s-triazine (RDX), and pentaerythritol tetranitrate (PETN).

29. A method for pre-concentrating any one or more of volatile compounds, explosives, and taggants in explosives for subsequent detection by an ion mobility spectrometry; comprising the steps of:
contacting a test object with a volume of gas;
exposing a solid phase microextraction (SPME) fiber to said gas to pre-concentrate any volatile compounds, explosives, and taggants of explosives within said object; and
introducing the SPME fiber into an apparatus for thermal desorption and introduction of one or more of volatile compounds, explosives, and taggants in explosives into an ion mobility spectrometry (IMS) for detection of the explosive.
